(19) United States
(12) Patent Application Publication
(10) Pub. No.: US 2015/0127323 A1
(43) Pub. Date: May 7, 2015

(54) REFINING INFERENCE RULES WITH TEMPORAL EVENT CLUSTERING

(71) Applicant: Xerox Corporation, Norwalk, CT (US)

(72) Inventors: Guillaume Jacquet, Ispra (IT); Shachar Mirkin, Meylan (FR)

(73) Assignee: Xerox Corporation, Norwalk, CT (US)

(21) Appl. No.: 14/070,786

(22) Filed: Nov. 4, 2013

(51) Int. Cl. G06F 17/27

(52) U.S. Cl. CPC G06F 17/2715; G06F 17/271
USPC 704/9

(57) ABSTRACT

A method for computing similarity between paths includes extracting corpus statistics for triples from a corpus of text documents, each triple comprising a predicate and respective first and second arguments of the predicate. Documents in the corpus are clustered to form a set of clusters based on textual similarity and temporal similarity. An event-based path similarity is computed between first and second paths, the first path comprising a first predicate and first and second argument slots, the second path comprising a second predicate and first and second argument slots, the event-based path similarity being computed as a function of a corpus statistics-based similarity score which is a function of the corpus statistics for the extracted triples which are instances of the first and second paths, and a cluster-based similarity score which is a function of occurrences of the first and second predicates in the clusters.

### BACKGROUND

The exemplary embodiment relates to semantic inference and finds particular application in connection with an automated system and method for inferring similarity between predicates.

Semantic inference is a common tool in natural language processing. For example, a question answering system which is requested to answer the question “Who founded XCorp?” could do so by searching for instances of “ . . . founded XCorp”. It may thus be able to extract the answer from instances like “YZ founded XCorp”, but will fail to do so from texts such as “XCorp was established by YZ”. It would be useful for the system to be able to infer that the latter sentence implies the former. The inference process typically depends on knowledge. For example, knowing that established and founded are synonyms in this context can help to answer the question based on the latter sentence. Inference rules are a common way to encode such knowledge. In this case, the required knowledge could be represented with the rule ‘found [symbol] establish’, meaning that found implies establish and vice-versa. Inference rules have been extensively used for many applications, including question answering (Harabagiu, et al., “Methods for using textual entailment in open domain question answering,” Proc. ACL 2006, pp. 905-912, 2006), multiple document summarization (Barzilay, et al., “Information fusion in the context of multi-document summarization,” Proc. 37^{th} Annual Meeting of the Association for Computational Linguistics, ACL '99, 1999), information extraction (Romano, et al., “Investigating a generic paraphrase-based approach for relation extraction,” Proc. EACL, 2006, pp. 409-416), text categorization (Barak, et al., “Text categorization from category name via lexical reference,” HLT-NAACL (Short Papers), pp. 33-36, 2009; Mirkin, et al., “Classification based contextual preferences,” Proc. TextInfer 2011 Workshop on Textual Entailment, pp. 20-29, 2011), machine translation (Mirkin, et al., “Source-language entailment modeling for translating unknown terms,” Proc. ACL-IJCNLP, ACL, pp. 791-799, 2009; Aziz, et al., “Learning an expert from human annotations in statistical machine translation: the case of out-of-vocabulary words,” Proc. 14^{th} Annual Meeting of EAMT, 2010), and textual entailment-based tasks (Dagan, et al., “Recognizing textual entailment: rational, evaluation and approaches,” Natural Language Engineering, 15(4): 1-17, 2009).

Methods have been developed for automatically Identifying similar predicates which can be used in generating such inference rules. One of these methods is based on the Discovery of Inferential Rules from Text (DIRT) algorithm (Dekang Lin and Patrick Pantel, “DIRT-discovery of inference rules from text,” KDD, pp. 323-328, 2001, hereinafter, “Lin 2001”). This unsupervised algorithm is based on an extended version of Harris' Distributional Hypothesis, which states that words that occur in the same contexts tend to be similar. Instead of using this hypothesis simply for words, the algorithm applies it to paths in the dependency trees of a parsed corpus.

The DIRT algorithm learns rules between predicates based on their common arguments, as learnt from corpus statistics. One issue with this approach, and with other methods based on distributional similarity, is their tendency to group together words (predicates in this case) that are semantically related but which do not conform to inference needs. A simplified example illustrates the problem:

1 (a) “Sally hates Harry”

1 (b) “Sally loves Harry”

Using the argument-similarity method, based solely on these sentences, a system could deduce that the predicates love and hate are similar since they share the same subject and the same object. This is true for other words of opposite meanings, such as in the following example:

2 (a) “Microsoft's revenue increased 2.7 percent to $21.46 billion”

2 (b) “Microsoft's revenue decreased 6.5 percent to $13.65 billion”

As numbers are typically normalized by statistical methods (to reduce sparsity, all numbers are often converted to a common symbol or a named entity), it could be deduced from corpus statistics that the two paths X increase by Y′ and ‘X decrease by Y’ are paraphrases.

There remains a need for an improved method for identifying similarity between paths for generating inference rules.

### INCORPORATION BY REFERENCE

The following references, the disclosures of which are incorporated herein in their entireties by reference, are mentioned: U.S. Pat. No. 7,058,567, issued Jun. 6, 2006, entitled NATURAL LANGUAGE PARSER, by Aït-Mokhtar, et al.; U.S. Pub. No. 20030101187, published May 29, 2003, entitled METHODS, SYSTEMS, AND ARTICLES OF MANUFACTURE FOR SOFT HIERARCHICAL CLUSTERING OF CO-OCCURRING OBJECTS, by Eric Gaussier, et al.; U.S. Pub. No. 20070143101, published Jun. 21, 2007, entitled CLASS DESCRIPTION GENERATION FOR CLUSTERING AND CATEGORIZATION, by Cyril Goutte; U.S. Pub. No. 20070239745, published Oct. 11, 2007, entitled HIERARCHICAL CLUSTERING WITH REAL-TIME UPDATING, by Agnes Guerraz, et al.; U.S. Pub. No. 20080249999, published Oct. 9, 2008, entitled INTERACTIVE CLEANING FOR AUTOMATIC DOCUMENT CLUSTERING AND CATEGORIZATION; U.S. Pub. No. 20100191743, published Jul. 29, 2010, entitled CONTEXTUAL SIMILARITY MEASURES FOR OBJECTS AND RETRIEVAL, CLASSIFICATION, AND CLUSTERING USING SAME, by Florent C. Perronnin, et al.; U.S. Pub. No. 20110276322, published Nov. 10, 2011, entitled TEXTUAL ENTAILMENT METHOD FOR LINKING TEXT OF AN ABSTRACT TO TEXT IN THE MAIN BODY OF A DOCUMENT, by Agnes Sandor, et al.; U.S. Pub. No. 20110137898, published Jun. 9, 2011, entitled UNSTRUCTURED DOCUMENT CLASSIFICATION., by Albert Gordo, et al.; U.S. Pub. No. 20120030163, published Feb. 2, 2012, entitled SOLUTION RECOMMENDATION BASED ON INCOMPLETE DATA SETS, by Ming Zhong, et al.; U.S. application Ser. No. 13/437,079, filed Apr. 2, 2012, entitled FULL AND SEMI-BATCH CLUSTERING, by Matthias Gallé, et al.; U.S. application Ser. No. 13/475,250, filed May 18, 2012, entitled SYSTEM AND METHOD FOR RESOLVING ENTITY COREFERENCE, by Matthias Gallé, et al.; and U.S. application Ser. No. 13/920,462, filed on Jun. 18, 2013, entitled COMBINING TEMPORAL PROCESSING AND TEXTUAL ENTAILMENT TO DETECT TEMPORALLY ANCHORED EVENTS, by Caroline Hagege and Guillaume Jacquet.

### BRIEF DESCRIPTION

In accordance with one aspect of the exemplary embodiment, a method for computing similarity includes extracting corpus statistics for triples from a corpus of text documents. Each triple includes a predicate and first and second arguments of the predicate. Documents in the corpus are clustered to form a set of clusters based on textual similarity and temporal similarity. An event-based path similarity is computed between first and second paths. The first path includes a first predicate and first and second argument slots. The second path includes a second predicate and first and second argument slots. The event-based path similarity is computed as a function of a corpus statistics-based similarity score which is a function of the corpus statistics for the extracted triples which are instances of the first and second paths, and a cluster-based similarity score which is a function of occurrences of the first and second predicates in the clusters.

In accordance with another aspect of the exemplary embodiment, a system includes a triple extraction component which extracts corpus statistics for triples from a corpus of text documents. Each triple includes a predicate and first and second arguments of the predicate. A clustering component clusters documents in the corpus to form a set of clusters based on textual similarity and temporal similarity. A path similarity component computes an event-based path similarity between first and second paths. The first path includes a first predicate and first and second argument slots. The second path includes a second predicate and first and second argument slots. The event-based path similarity is computed as a function of a corpus statistics-based similarity score, which is a function of the corpus statistics for the extracted triples which are instances of the first and second paths, and a cluster-based similarity score, which is a function of occurrences of the first and second predicates in the clusters. A processor implements the triple extraction component, clustering component, and path similarity component.

In accordance with another aspect of the exemplary embodiment, a method for refining inference rules includes computing a first similarity score for first and second paths based on corpus statistics extracted for triples from a corpus of text documents. The first path includes a first predicate and respective first and second argument slots. The second path includes a second predicate and respective first and second argument slots. Each triple includes one of the first and second predicates and first and second arguments of that predicate that are instances of the respective first and second argument slots. The method further includes computing a second similarity score for the first and second paths based on a similarity between occurrences of the paths in a set of document clusters formed by clustering documents in the corpus based in part on temporal stamps of the documents. An event-based path similarity is computed between the first and second paths as a function of the first and second similarity scores. An inference rule is generated for the first and second paths based on whether the event-based path similarity meets a predetermined threshold.

### BRIEF DESCRIPTION OF THE DRAWINGS

FIG. 1 is a functional block diagram of a system for computing path similarity and refining inference rules;

FIG. 2 is a flow chart illustrating a method for computing path similarity and refining inference rules; and

FIG. 3 illustrates an example parse tree for an input sentence.

### DETAILED DESCRIPTION

Aspects of the exemplary embodiment relate to a system and method for automatically identifying similar paths based on corpus statistics and temporal clustering.

The identification of similar paths is based on event clustering information under the assumption that related predicates will occur more often in the same events. This allows inference rules to be generated based on the identified, similar paths. In the exemplary embodiment, an unsupervised temporal-based clustering of events is used, and the cluster structure is used to weight candidate inference rules. Using a more accurate set of rules directly impacts the inference and results in better application performance. The utility of the refined rules is demonstrated below on a document clustering task where the refined rules improve the clustering. Semantic inference, and inference rules that enable it, are not limited to the clustering task but can be employed in many NLP applications, such as information extraction, question answering, and document summarization.

A “path,” as used herein is a syntactic construct around a binary predicate, i.e., a predicate with two slots (i.e., variables) for the predicate's arguments (the subject and object of the predicate). In the path, the predicate is represented by its root (e.g., infinitive) form. An instance of a path is a triple in which the two slots are occupied by respective instances of the arguments and the predicate may be any of the forms of the predicate accepted in the particular grammar of the natural language under consideration. The instance of the path may be found in a corpus of text documents by parsing of the corpus documents. For example a path for the predicate find could be represented as:

X:subj:V←find→V:obj:Y (Ex. 1)

where X is the subject of the verb find and Y is the object of the verb find. An instance of this path could be the triple (Harry, find, Sally) where Harry is the subject of the verb find, occupying the first slot and Sally is the object of find, occupying the second slot. The triple could be identified in the corpus by parsing a sentence such as “Yesterday, Harry found Sally in the park.”

As another example, the relation ‘X finds solution to Y’ is represented with the path:

N:subj:V←find→V:obj:N→solution N:to:N (Ex. 2)

For example, the above path can be instantiated with the words government or committee for the first slot (the subject) and crisis or strike for the second (the object).

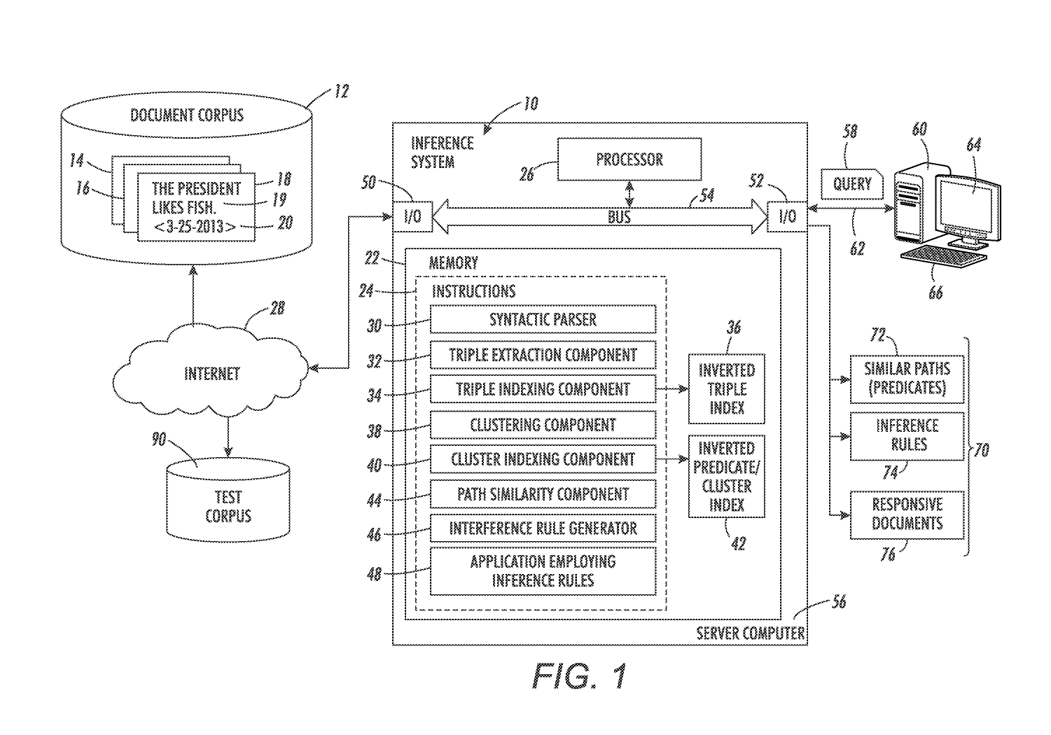

FIG. 1 illustrates a system 10 for computing similarity between two paths of the type exemplified, and/or for generating inference rules based thereon. The system 10 has access to a corpus 12 of documents 14, 16, 18, each document including text 19 in a natural language, such as English or French. The text 19 of each document 14, 16, 18 includes one or more text strings, such as sentences, e.g., a paragraph or more of text in the natural language. In one embodiment, the documents 14, 16, 18 in the corpus 12 are news articles on different subjects. Each document has an associated time stamp 20 or other temporal information relating to the date of creation, publication, or the like. The temporal information 20 may be stored as metadata of the document, or may be extracted from the text of the document. The corpus 12 may include at least 100, or at least 1000 or 10,000 of such documents.

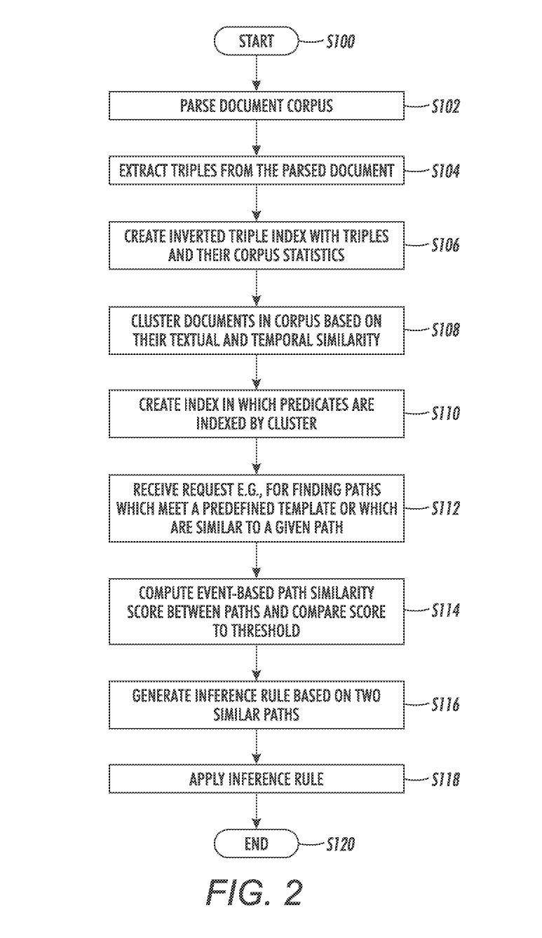

The system includes memory 22 which stores instructions 24 for performing the method described with reference to FIG. 2 and a processor 26 in communication with the memory for executing the instructions. The document corpus 12 may be stored in memory 20 or in a remote memory storage device which is accessible to the system. In the exemplary embodiment, the document corpus is stored in remote memory which is linked to the system 10 by a wired or wireless link 28, such as a local area network or a wide area network, such as the Internet.

The exemplary instructions 24 include a syntactic parser 30, which parses the documents in the corpus 12 to generate parse trees in which dependencies between predicates and their respective arguments are identified. The parser may include a named entity recognition component which identifies named entities (e.g., names of people, organizations, and places) and tags them as nouns.

An extraction component 32 extracts triples from the parsed documents, each triple corresponding to an instance of a path. In each triple, the words are represented by their lemma (root) forms. For example, the predicate finds is reduced to the lemma (infinitive) form find. Plural nouns may be reduced to their singular form. The extraction component 32 counts the number of occurrences (instances) of each triple in each document. Each document in the corpus may be given an identifier which uniquely identifies that document and the occurrences for each document are recorded.

An indexing component 34 creates an inverted index 36 based on the corpus statistics of each triple generated by the extraction component. The index can be accessed by any one or more of the elements in the triple (subject, object, and/or predicate).

A clustering component 38 clusters the documents in the corpus based on textual similarity, taking into consideration the temporal information, such that a document which is spaced by more than a threshold time interval from all the documents in a given cluster is automatically assigned to a different cluster, irrespective of its textual similarity. In the exemplary embodiment, each document 14, 16, 18 is assigned to a single cluster, i.e., to no more than one cluster and at least some of the clusters each include a plurality of documents.

A cluster indexing component 40 creates a cluster index 42 based on the predicates found in the documents that are assigned to each cluster.

A path similarity computing component 44 is configured for computing an event-based path similarity between two paths. For purposes of discussion, the first and second slots of a first path P₁ are designated X₁ (e.g., the subject) and Y₁ (e.g., the object), and of a second path P₂ are correspondingly designated X₂ and Y₂. Each path has a respective predicate, denoted p₁ and p₂. As will be appreciated, in an instance of a given path, the predicate is always the same, while the slots can be occupied by different words, depending on the occurrences of the path in the corpus 12. The overall similarity is a function of two components:
1) a slot similarity, computed for the first pair of slots: (X₁, X₂), based on the co-occurrences of the same instance of the first slot with each predicate p₁ and p₂, in the corpus, and for the pair of second slots (Y₁, Y₂), based on the co-occurrences of the same instance of the second slot with each of predicates p₁ and p₂, in the corpus.
2) a cluster similarity, based on each path's occurrences in the clusters.

The statistics used for computing the similarity are retrieved from the inverted indexes.

In one embodiment, the path similarity component 44 is input with a template which defines more than one path, such as:

N:subj:V←predicate→V:obj:N→solution N:to:N

which covers paths with different predicates each having an instance in the corpus where a first noun is a subject of a predicate which has as its object solution to followed by a second noun. The path similarity computation component then computes similarity between all paths that meet the template.

The path similarity component 44 outputs an event-based path similarity score which may be compared to a threshold similarity, γ. If the threshold is met, the two paths, and hence their respective predicates, are considered to be equivalent, and may be output as equivalent paths/predicates and/or incorporated into an inference rule by an inference rule generator 46. The inference rules generated in this way can then be applied by an application component 48, such as question answering system, information extraction system, question answering system, document summarization system, document clustering system, or the like, or for any other task where inference rules are employed. As will be appreciated, the inference rule generator 46 and/or application component 48 may be hosted by a separate computing device.

The system may include one or more input/output (I/O) interfaces 50, 52 for communicating with external devices. The hardware components 20, 24, 50, 52 of the system may be communicatively connected by a data/control bus 54. The system 10 may be hosted by one or more computing devices, such as the illustrated server computer 56. A query 58, e.g., a request for a path similarity computation may be received from an external device 60, such as the illustrated client device that is communicatively linked to the system by a wired or wireless connection 62, and/or the request may be generated internally by the system. The client device and/or the computing device 56, may communicate with one or more of a display 64, for displaying information to users, and a user input device 66, such as a keyboard or touch or writable screen, and/or a cursor control device, such as mouse, trackball, or the like, for inputting text and for communicating user input information and command selections to the respective processor.

The system 10 receives the request 58 and outputs information, such as information 72 identifying whether two paths/predicates are similar. In another embodiment, the system outputs inference rules 74 based on similar paths. In another embodiment, the request 58 may be in the form of a query seeking information (such as “Who founded XCorp?”) and the system outputs information, such as responsive documents drawn from a document collection, based on the application of inference rules by the application 48.

The computer 56 may include one or more computing devices, such as a PC, such as a desktop, a laptop, palmtop computer, portable digital assistant (PDA), server computer, cellular telephone, tablet computer, pager, combination thereof, or other computing device capable of executing instructions for performing the exemplary method. Computer 60 may be similarly configured to computer 56, with memory and a processor.

The memory 22 may represent any type of non-transitory computer readable medium such as random access memory (RAM), read only memory (ROM), magnetic disk or tape, optical disk, flash memory, or holographic memory. In one embodiment, the memory 22 comprises a combination of random access memory and read only memory. In some embodiments, the processor 26 and memory 22 may be combined in a single chip.

The network interface 50, 52 allows the computer to communicate with other devices via a computer network, such as a local area network (LAN) or wide area network (WAN), or the internet, and may comprise a modulator/demodulator (MODEM) a router, a cable, and and/or Ethernet port.

The digital processor 26 can be variously embodied, such as by a single-core processor, a dual-core processor (or more generally by a multiple-core processor), a digital processor and cooperating math coprocessor, a digital controller, or the like. The digital processor 26, in addition to controlling the operation of the computer 56, executes instructions stored in memory 22 for performing the method outlined in FIG. 2.

As will be appreciated, in some embodiments, the instructions 24 may be distributed over computing devices 56 and 64, or the two computing devices combined into a single computing device.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system.

FIG. 2 illustrates a method for computing path similarity. The method begins at S100.

At S102, the document corpus 12 is automatically parsed by the syntactic parser 30 to generate parse trees in which dependencies between predicates and their respective arguments are identified.

At S104, triples are automatically extracted from the parsed documents, by the extraction component 32 and the number of occurrences of each triple in each document are counted and stored in memory 22.

At S106, an inverted triple index 36 is automatically created by the indexing component 34 and stored in memory 20.

At S108, the documents in the corpus 12 are clustered into a set of clusters, based on their textual similarity and temporal similarity, by the clustering component 38.

At S110, the predicates are indexed by cluster, by the cluster indexing component 40. The cluster-indexed predicates may be output and/or used by the system as follows:

At S112, a query, such as a request for a similarity computation, may be received. The request may specify one path and ask for similar paths to be identified, ask for paths which meet a predefined template to be found, request computing a similarity between first and second specified paths P₁ and P₂, request documents which satisfy a query based on the application of inference rules, or the like. As will be appreciated the request may be received earlier in the method, e.g., prior to extracting triples from the parsed document corpus. Alternatively, the system automatically searches for paths which are similar and outputs all, or a set of pairs of paths which meet a threshold similarity.

At S114, the similarity between paths P₁ and P₂ is computed by the similarity component 46, which takes into consideration the instances of the two paths in temporally constrained clusters. A similarity score is output and/or stored in memory. The similarity score may be compared to a threshold to determine if two paths/predicates meet the predefined similarity threshold γ, and therefore are considered similar. If the threshold is not met, the paths/predicates are considered as not similar.

At S116, an inference rule may be generated which provides for instances of two (or more) paths/predicates that have been determined to be similar to be treated as equivalent, at least in some circumstances.

At S118, the inference rule may be applied by the application component 48 in an information processing task.

The method ends at S120.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 56, (for example, an internal hard drive of RAM), or may be separate (for example, an external hard drive operatively connected with the computer 56), or may be separate and accessed via a digital data network such as a local area network (LAN) or the Internet (for example, as a redundant array of inexpensive of independent disks (RAID) or other network server storage that is indirectly accessed by the computer 56, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually.

Further aspects of the system and method will be now described in further detail.

### Syntactic Parsing (S102)

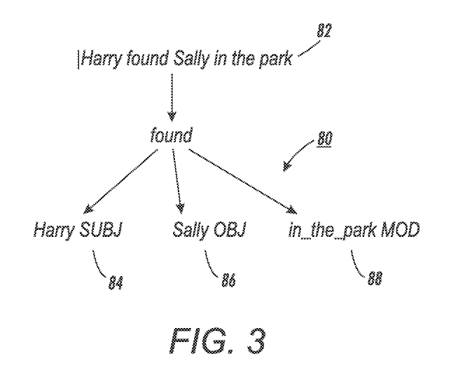

The parser 30 processes the text of the documents in the corpus. The parser may comprise any suitable syntactic dependency parser which is configured for generating a parse tree. During parsing of the document, the parser annotates the text strings of the document with tags (labels) which correspond to grammar rules, such as lexical rules and syntactic and/or semantic dependency rules. The lexical rules define features of terms such as words and multi-word expressions. The lexical rules may include assigning parts of speech to terms in the text, such as noun, verb, etc., from a predefined set of parts of speech to be recognized. The dependency rules include rules for identifying dependency relations between terms, such as SUBJ (a dependency between the subject of the sentence and the predicate verb) and OBJ (a dependency between the object of the sentence and the predicate verb). Syntactic rules describe the grammatical relationships between the words, such as subject-verb, object-verb relationships. Semantic rules include rules for extracting semantic relations such as co-reference links. The application of the rules may proceed incrementally, with the option to return to an earlier rule when further information is acquired. The labels applied by the parser may be in the form of tags, e.g., XML tags, metadata, log files, or the like. The parser outputs for each text string, such as a sentence, a parse tree in which nouns are linked to the verbs and other words where a dependency has been identified. See, for example FIG. 3, where a parse tree 80 is generated from an input text string 82 which includes a subject (SUBJ) relationship 84, an object (OBJ) relationship 86, and a modifier relationship (MOD) 88. The modifier relationship can be ignored if the algorithm does not consider such relationships.

The following disclose a parser which is useful herein for syntactically analyzing an input text string in which the parser applies a plurality of rules which describe syntactic properties of the language of the input text string: U.S. Pat. No. 7,058,567, issued Jun. 6, 2006, entitled NATURAL LANGUAGE PARSER, by Aït-Mokhtar, et al., and Aït-Mokhtar, et al., “Robustness beyond Shallowness: Incremental Dependency Parsing,” Special Issue of NLE Journal, 8(2-3):121-144 (2002), hereinafter, “Aït-Mokhtar 2002”. Other suitable incremental parsers are described in Aït-Mokhtar “Incremental Finite-State Parsing,” in Proc. 5th Conf. on Applied Natural Language Processing (ANLP'97), pp. 72-79 (1997), and Aït-Mokhtar, et al., “Subject and Object Dependency Extraction Using Finite-State Transducers,” in Proc. 35th Conf. of the Association for Computational Linguistics (ACL'97) Workshop on Information Extraction and the Building of Lexical Semantic Resources for NLP Applications, pp. 71-77 (1997). The syntactic analysis may include the construction of a set of syntactic relations (dependencies) from an input text by application of a set of parser rules. Exemplary methods are developed from dependency grammars, as described, for example, in Mel'\check{c}uk I., “Dependency Syntax,” State University of New York, Albany (1988) and in Tesnière L., “Elements de Syntaxe Structurale” (1959) Klincksiek Eds. (Corrected edition, Paris 1969). By way of example, the Xerox Incremental Parser (XIP) may be used as the document parser.

The exemplary parser 30 may incorporate rules for named entity detection or a separate component may be used for the task. Systems and methods for identifying named entities and proper nouns are described, for example, in Aït-Mokhtar 2002; U.S. Pat. No. 7,058,567, entitled NATURAL LANGUAGE PARSER, by Aït-Mokhtar, et al. U.S. Pat. No. 7,171,350, entitled METHOD FOR NAMED-ENTITY RECOGNITION AND VERIFICATION, by Lin, et al.; U.S. Pat. No. 6,975,766, entitled SYSTEM, METHOD AND PROGRAM FOR DISCRIMINATING NAMED ENTITY, by Fukushima; U.S. Pub. No. 20080319978, published Dec. 25, 2008, entitled A HYBRID SYSTEM FOR NAMED ENTITY RESOLUTION, by Caroline Brun, et al., and U.S. Pub. No. 20100082331, published Apr. 1, 2010, entitled SEMANTICALLY-DRIVEN EXTRACTION OF RELATIONS BETWEEN NAMED ENTITIES, by Caroline Brun, et al., U.S. Pub. No. 20100004925, published Jan. 7, 2010, entitled CLIQUE BASED CLUSTERING FOR NAMED ENTITY RECOGNITION SYSTEM, by Julien Ah-Pine, et al., U.S. Pub. No. 20090204596, published Aug. 13, 2009, entitled SEMANTIC COMPATIBILITY CHECKING FOR AUTOMATIC CORRECTION AND DISCOVERY OF NAMED ENTITIES, by Caroline Brun, et al.; the disclosures of which are incorporated herein by reference in their entireties.

### Extraction of Triples (S104) and Creation of Triple Index (S106)

Prior to computing the event-based path similarity, corpus statistics are collected. For example, for every path, all the occurrences of nouns that instantiate each of its two slots are logged, as well as the frequency of these instantiations (e.g., number of occurrences, in the document corpus 12).

For example, the path in Ex. 2 above could be instantiated with the words government or committee for the first slot (the subject) and crisis or strike for the second (the object). If there are two occurrences in the document corpus of the path government and crisis in respective slots with a predicate having the lemma find, the triple (government, find, crisis) is indexed together with its frequency of 2, and the identifiers of the documents in which the triple was found.

In general only the head noun is considered as an argument in the case where a noun phrase is identified by the parser as the subject or object of a predicate. However, recognized named entities may be considered as a single word, even where the name is two or more words in length.

### Event Clustering (S108)

In the clustering of documents, temporal-based event clustering allows refinement of inference-based rules.

As an example, an event is a set of news articles reporting about the same concrete topic, e.g., news articles about the US President's Trip to India in 2010. Event-based clustering has previously been considered in the context of the Topic Detection and Tracking (TDT) task (James Allan, Ron Papka, and Victor Lavrenko, “On-line new event detection and tracking,” Proc. 21st Annual Intern'l ACM SIGIR Conf. on Research and Development in Information Retrieval, pp. 37-45. ACM, 1998). This task involves monitoring news providers in order to extract events and merge articles (or part of articles) related to the same event. As an example, the TDT5 (Topic Detection and Tracking) corpora is a set of English newswire texts used in the 2004 Topic Detection and Tracking technology evaluations. See David Graff, et al., “TDT5 multilingual text,” 2004. In the example below, the TDT5 corpora were used in an evaluation of the method, however, it is to be appreciated that other corpora may be used, which may depend, in part, on the application in which the inference rules are to be utilized.

In the exemplary method, the clustering takes into consideration the temporal aspect. The basis for this approach is that events sharing the same temporal stamp 20 (or close temporal stamps) should have a higher probability of being grouped together. The clustering is therefore performed by taking into account normalized temporal entities (e.g., dates) extracted from the text for measuring similarities of documents, in addition to their word similarities. For example, July 15th may be normalized to Jul. 15, 2003, based on information on the year of creation (2003). More discrete time frames may be considered, such as hours or minutes, if appropriate and available.

An incremental clustering algorithm with temporal constraints can be used. Given a next document, the clustering component compares it, optionally also considering its timestamp, to existing clusters and decides to assign it to one of the existing ones (Topic Tracking) or to create a new one (New Topic Detection). To further enforce the temporal constraint, if a cluster has not been updated for a certain amount of time, it cannot be updated with new documents. For example if a document has a time stamp that is more than a predetermined number n of days (or other temporal units in which the timestamps are defined) after the latest document timestamp in the cluster (or the mean timestamp of some or all the documents in the cluster), it cannot be added to that cluster and so it becomes the basis for a new cluster. For example, in the case of timestamps defined in increments of days, the number n may be at least two or at least 5 days, such as 10-50 days.

Examples of clustering methods useful herein are described in Aurora Pons-Porrata, et al., “Detecting events and topics by using temporal references,” Advances in Artificial Intelligence IBERAMIA 2002, pp. 11-20 (2002), Matthias Gallé and Jean-Michel Renders, “Full and mini-batch clustering of news articles with star-EM,” Advances in Information Retrieval, pp. 494-498 (2012), and in U.S. application Ser. No. 13/437,079, filed Apr. 2, 2012, entitled FULL AND SEMI-BATCH CLUSTERING, by Matthias Gallé et al.

For example, a multidimensional statistical representation of the text of at least a part of each document is generated, such as the text of the first paragraph or the first n words, where n may be about 100. The representation can be a bag-of-words representation. For example, a set of terms occurring throughout the corpus is identified, such as named entities and unigrams, and the frequency of each of these terms in the document (or document part) is computed. A document vector is then generated in which each slot corresponds to a term and the value of the slot is based on the computed frequency. In one embodiment, in order to compute the value, a transformation, such as a term frequency-inverse document frequency (TF-IDF) transformation, may be applied to the term frequencies to reduce the impact of words which appear in all/many documents. The word/phrase frequencies are normalized (e.g., L2 normalized) to allow meaningful comparisons between documents. The result is a vector of normalized frequencies (a data point), where each element of the vector corresponds to a respective dimension in the multidimensional space.

In one embodiment, named entities within the text are flagged and may be used as features in the textual representation. Named entities of interest include person and organization names, and location names. By way of example, the Xerox Incremental Parser (XIP) may be used for the named entity recognition task, as described above.

During cluster assignment, the textual representation of a new document is compared to the representation of each existing cluster's centroid or other representative point in the cluster, using, for example a cosine similarity or other comparison measure. The centroid is the geometric center of the cluster and can be computed by computing the average (mean) of each slot for the documents already in the cluster.

The document is generally assigned to the cluster with which it has the greatest textual similarity. However, if the computed textual similarity does not meet a predetermined threshold textual similarity θ with any of the existing clusters, a new cluster is started. Additionally, if the temporal similarity does not meet a threshold temporal similarity with the most similar cluster (based on its time stamp), a new cluster is started. An iterative clustering method as described in application Ser. No. 13/437,079, may be employed which includes clustering the data points among the clusters by assigning the data points to the clusters based on a comparison measure of each data point with a representative point of each cluster (after optionally subtracting the threshold similarity), and based on the clustering, computing a new representative point for each of the clusters, which serves as the representative point for a subsequent iteration.

The clustering results in each document being assigned to exactly one of the resulting clusters and documents which are not temporally similar to each other being assigned to different clusters.

### Creation of Predicate Index (S110)

Once the clusters have been generated, a predicate cluster index 42 may be created which identifies, for each predicate (i.e., path) found in the document corpus (or for at least a subset of the predicate/paths which may have, for example a threshold number of occurrences in the corpus), the clusters in which that predicate/path appears.

### Similarity Computation (S114)

The computation of the event-based similarity between paths can be implemented using inference rules learnt with the DIRT algorithm (Lin 2001), which is modified, as described below, with an update function which uses the cluster assignments of the predicates to introduce a temporal weighting to the path similarity computed by the DIRT algorithm. A brief description of the basic DIRT algorithm follows, then a description of the adaptation used herein.

1. Corpus-Statistics-Based Similarity Score

DIRT is an extension of the distribution similarity algorithm proposed by Dekang Lin (Dekang Lin, “Automatic retrieval and clustering of similar words,” Proc. COLING-ACL, Montreal, Quebec, Canada, 1998, hereinafter, “Lin 1998”). Where Lin's work addresses word similarity, the goal in DIRT is to learn similarity between paths in dependency parse trees, such that given a path, its most similar paths can be retrieved.

Using the corpus statistics collected at S106, the path similarity, i.e., the similarity between each pair of paths based on the respective similarities of the two slots of each path, can be computed as shown in Equation (1).

dirt(P₁,P₂)=√\dot{×}\dot{×}sim(slotY₁,slotY₂))} (1)

Here, Pᵢ denotes a path (i ∈ {1,2}), slotXᵢ is the first slot (the subject) in path i and slotYᵢ is its second slot (the object). sim is the computed similarity between two slots and is based on all the instantiations of the slots (in a path with the respective predicate) in the corpus. Thus, the DIRT score is the geometric mean of the similarity of the two pairs of slots, given the respective predicates p₁,p₂ in the two paths.

The similarity between a pair of slots slot₁,slot₂ (=slotX₁,slotX₂ or slotY₁,slotY₂) can be a function of the pointwise mutual information (PMI) between each slot and its respective predicate for all words that are found in the corpus in both slots slot₁,slot₂ e.g., the similarity between a pair of slots is defined (as presented in Lin 1998) as shown in Equation (2):

$$sim ( {slot}_{1} , {slot}_{2} ) = \frac{\begin{matrix}{\sum }_{w ∈ T}^{ } ( {p}_{1} , {slot}_{1} ) ⋂ \\ T ( {p}_{2} , {slot}_{2} ) pmi ( {p}_{1} , {slot}_{1} , w ) + \\ pmi ( {p}_{2} , {slot}_{2} , w )\end{matrix}}{\begin{matrix}{\sum }_{w ∈ T}^{ } ( {p}_{1} , {slot}_{1} ) pmi ( {p}_{1} , {slot}_{1} , w ) + \\ {\sum }_{w ∈ T}^{ } ( {p}_{2} , {slot}_{2} ) pmi ( {p}_{2} , {slot}_{2} , w )\end{matrix}} \qquad ( 2 )$$

T(p₁,slot₁) is the set of words w that fill the slot slot₁ (e.g., first slot) of path P₁, and similarly T(p₂,slot₂) is the set of words that fill the same slot slot₂ (e.g., first slot) of path P₂, i.e., its argument instantiations, thus T(p₁,slot₁) ∩ T(p₂,slot₂) represents the set of words that occur in slot₁ and also in slot₂. pmi denotes the Pointwise Mutual Information (PMI) between the predicate and the argument instantiation (where word w occupies an argument slot), which can be defined as follows:

$$pmi ( p , Slot , w ) = log ( \frac{\vert p , Slot , w \vert \vert * , Slot , * \vert}{\vert p , Slot , * \vert \vert * , Slot , w \vert} ) \qquad ( 3 )$$

where Slot is slot₁ or slot₂, |p,Slot,w| is the frequency of that triplet in the corpus (e.g., the count of its occurrences), and * denotes any word or any predicate, according to its position in the triplet.

2. Cluster Similarity-Based Score

In the exemplary method, cluster similarity is used to refine the path similarity (e.g., DIRT) scores and is based on the event clustering information generated at S108, S110. To obtain a refined score, the scores of the DIRT rules defined above are updated, based on the clustering, with an update function u, such that u favours DIRT paths which are in the same clusters. The exemplary update function u is computed as the cluster similarity between two paths. The resulting event-based path similarity score is denoted edi.

To compute the update, the occurrences of a predicate pₖ in each cluster are represented by a vector vₖ with an entry for each cluster. The entry may be binary, i.e., 1 if the predicate (i.e., a path with that predicate) is found in the cluster and 0 otherwise. The vector vₖ can be generated from the predicate/cluster index 42.

The exemplary update function u is based on a similarity between the vectors vₖ for two predicates. In one embodiment, the update function u is defined as follows: u(pᵢ,pⱼ)=cosine(vᵢ,vⱼ), i.e., the cosine similarity between the two vectors vₖ of predicate occurrences. The resulting event-based path similarity score edi is then computed as a function of the update function (cluster similarity) u(pᵢ,pⱼ) and the path similarity (i.e., similarity between each pair of paths based on the similarities of the first and second slots (e.g., dirt score dirt(pᵢ,pⱼ)). In one embodiment, the event-based path similarity score is computed as a product of the two:

edi(pi,pj)=dirt(pᵢ,pⱼ)·u(pᵢ,pⱼ)=dirt(pᵢ,pⱼ)·cosine(vᵢ,vⱼ) (4)

Since the value of the cosine is between 0 and 1, with higher values being obtained when the two vectors vᵢ,vⱼ are more similar, the resulting edi score is never greater than the dirt score, and is substantially lower when the two vectors are dissimilar.

While in the exemplary embodiment the event-based path similarity score is a product of the corpus statistics-based path similarity score dirt(pᵢ,pⱼ) and the cluster similarity based score u(pᵢ,pⱼ), other functions which provide an aggregation of the two scores are contemplated, such as a sum of the two scores or the like.

Computing the dirt score dirt for all possible predicate pairs may be time-consuming as there are numerous pairs in the corpus 12, most of which do not occur in a given test set on which the inference rules are to be applied. While filtering methods may be employed to remove less frequent pairs, in one embodiment, the problem of computing a huge number of predicate similarities in advance is avoided by computing only the required dirt scores on the fly. To that end, the path similarity component provides a local service which can be run that, when queried with two predicates, returns the dirt or edi scores, based on the statistics instantly retrievable through the inverted indexes 36, 42.

To compute the path similarity score, e.g., dirt score, each predicate-argument's occurrence is indexed in the inverted index 36, such that the list of all subject or object instantiations is retrievable through the predicate. This index can then be used to retrieve the statistics needed to obtain the counts used in Equation (3), and the word lists in Equation (2). For edi, the cosine similarity between the two predicates is also computed. The cosine similarity between predicates p₁ and p₂ can be defined as follows.

$$cosine ( {p}_{1} , {p}_{2} ) = \frac{{\sum }_{k = 1}^{n} {v}_{1}^{k} {v}_{2}^{k}}{\sqrt{{\sum }_{k = 1}^{n} {v}_{1}^{{k}^{2}}} \sqrt{{\sum }_{k = 1}^{n} {v}_{2}^{{k}^{2}}}} \qquad ( 5 )$$

where vᵢ is the cluster-vector of predicate pᵢ, vᵢ^{k} is its k^{th} entry, and n is the size of this vector, i.e., the number of clusters.

In the case of a binary cosine similarity (i.e., where the number of times each predicate occurred in each cluster is not counted, but just whether it occurred in the cluster or not) the dot product v₁^{k}v₂^{k} in the numerator of Eq. 5 is simply the number of clusters in which both predicates occur. Additionally, each of the two sums in the denominator is the number of clusters in which the corresponding predicate occurred.

Hence, the binary cosine similarity cosine_{B} can be reduced to:

$${cosine}_{B} ( {p}_{1} , {p}_{2} ) = \frac{count ( p 1 , p 2 )}{\sqrt{count ( p 1 ) cound ( p 2 )}} \qquad ( 6 )$$

Hence, to compute edi, the occurrences of predicates in the clusters are indexed. Each cluster is treated as an IR (Information Retrieval) document. Then, given two predicates, the method retrieves: (i) the number of clusters each predicate appears in, and (ii) the number of clusters both predicates appear in. This is sufficient for computing the cluster-based cosine similarity between the predicates which serves as the cluster similarity (or on which the cluster similarity is based).

Once the event-based path similarity score edi is computed, it can be compared to a predetermined threshold γ. The threshold can be determined empirically, for example, by evaluating the results using a set of different thresholds. In practice, the predetermined threshold γ is lower than the threshold which is conventionally used for determining dirt scores, since the event-based path similarity score edi is generally lower than the dirt score. For example the threshold may be 0.5 or lower, such as 0.1 or lower.

### Creation of Inference Rules (S116)

The exemplary method is not limited to any specific inference rules and these may be tailored to meet the particular application in which the rules are to be used.

As an example, an inference rule can be of the type:

If edi(pi,pj)>γ then pi=pj (and/or vice versa)

where γ is the similarity threshold.

However, more complex rules could be created, depending on the application, which add further constraints, such as:

If edi(pi,pj)>γ and X₁ is a person-type named entity, then pi=pj (and/or vice versa).

### Application of Inference Rules (S118)

The exemplary method is not limited to any specific application. Examples of applications in which the inference rules may be used include:

1. Information retrieval: e.g., a query which looks for documents in a test corpus 90 which satisfy “ . . . founded XCorp” that now considers “ . . . established XCorp” as equivalent when paths based on found and establish have been found to meet a similarity threshold.

2. Clustering of documents: e.g., word-based representations of documents (which can be from a different collection than the corpus 12) are modified so that the value for found and establish are treated as being the same when paths based on found and establish have been found to meet a similarity threshold. The documents are then clustered based on the modified representations.

3. Text categorization: e.g., as for clustering, modified word-based representations of documents are generated and documents are categorized into one or more of a set of predefined categories, e.g., using a document classifier, based on the representations.

4. Machine translation: e.g., a translation of a source text in a first language to a target text in a target language is generated in which a source word or translated word is substituted with a word found to meet a similarity threshold. The same approach may also be used for authoring text, where there is no translation but simply a revised text is generated in the same language.

5. Textual entailment-based tasks: the similar words identified may be used to determine whether a first sequence of words entails a second sequence of words, i.e., has the same meaning, by applying a set of entailment rules, one or more of which may include an inference rule that similar paths/predicates are equivalent. See, for example, US Pub. No. 20110276322, incorporated herein by reference in its entirety.

Without intending to limit the scope of the exemplary embodiment, the follow examples demonstrates the advantage of using inference rules based on the exemplary edi similarity measure in a clustering application.

### EXAMPLE

In this example, inference rules using predicates identified based on their similarity scores are used in a document clustering task.

There are several ways to assess the quality of a repository of inference rules. One is to manually assess their correctness (as defined by some criteria) and show the percentage of correct vs. incorrect rules. This method, sometimes known as “rule-based” evaluation, suffers from two main problems. First, it requires manual effort, and second, it does not assess the actual utility of the repository, as the repository may contain, for instance, many correct rules that are never used. A different approach is called “instance-based”, where the practical utility of the resource is evaluated, e.g., according to its contribution to some natural language processing (NLP) task. This is the approach followed in these examples. Since no ground truth exists to measure the quality of the edi score in comparison to the dirt score, document clustering is chosen as a measurable task and an evaluation is made as to how helpful the dirt and edi scores are for this task.

The following notation is used:

Test set, T: an set of documents to be clustered (corresponding to test corpus 70).

Gold Standard, G: the correct clustering of T as defined by human annotators.

Development set, D: a set of documents from the same domain as the test set, which are used to collect statistics of predicates (corresponding to document corpus 12).

### Computing Predicate Similarity

1. Parsing: The corpus D is parsed with the syntactic parser 30 (S102).

2. Extracting predicate-argument triples (S104). At the first stage, triples of binary predicates and their arguments are extracted from D, along with their counts. For example, [symbol] vehicle approach_OBJ-N checkpoint, 4 [symbol] means that the predicate approach occurred in the corpus four times with vehicle as its subject and checkpoint as its object.

3. Indexing predicate-arguments (S106). An inverted-index 36 is created of the predicate-argument statistics of the corpus D, where each triplet corresponds to a search-engine document. Retrieval, by each of the elements among the predicate, subject and object is enabled, which enables obtaining statistics of occurrences and co-occurrences, needed for computing dirt scores as explained above.

4. Clustering documents (S108): the clustering algorithm is applied to D, in order to obtain clustering information.

5. Indexing clusters (S110). Based on the clustering created in the previous step, a second inverted-index 42 is created for the predicate-argument divided to cluster. Here, an entire cluster is treated as a single document, as only the statistics of joint and separate occurrences of predicate pairs are needed.

This index is used for computing the cluster similarity part of the edi score.

For comparison, inference rules are generated based on dirt scores and on edi scores.

Clustering Test Set with Inference Rules (S118)

As noted above, this is the application on which the inference rules are being tested, not part of the method for generating the inference rules. The clustering of the test set is performed as follows:

1. Construct document vectors. The test set T is parsed and each document d is represented by a vector v_{d}. Each vector v_{d} consists of the document's bag-of-words as well as the predicates that appear in it.

2. Updating vectors. Based on the metric used (dirt or edi), features are merged (in this case only predicates) as follows:

Each pair of predicates is defined as being identical (i.e., corresponding to the same feature) if dirt(pᵢ,pⱼ)>γ₁ (or edi(pᵢ,pⱼ)>γ₂), where γ₁ and γ₂ are experimentally set similarity thresholds (in these experiments, the same value of γ was used, i.e., γ₁=γ₂). If two predicates (features) are considered identical, then for each feature vector v_{d},

v_{d}(pᵢ)=v_{d}(pᵢ)+v_{d}(pⱼ) and v_{d}(pⱼ)=0.

3. Clustering the test set. With the updated vectors, the test set T is clustered.

In the experiments, the Xerox Incremental Parser (XIP) was used as the syntactic parser 30 (Aït-Mokhtar 2002). The TDT5 dataset, which contains a corpus of English newswire texts used in the 2004 Topic Detection and Tracking technology evaluations, was used to provide the corpus D and the test set T. This dataset provides manually annotated events, where each event is a set of news articles reporting on the same concrete and precise topic. The dataset contains almost 280,000 documents including 6,364 documents annotated with 126 events (called “stories” or “topics” in TDT5). These annotated documents were taken as the gold standard for assessing the clustering performance. The clusters, produced with the incremental clustering algorithm, were evaluated against the gold standard using Micro-average Precision and Recall.

The clusters, produced with the incremental clustering algorithm, were evaluated against the gold standard using Micro-average Precision and Recall.

Since there are multiple ways to map between two cluster-sets, for each configuration, the mapping between the automatically identified clusters and the reference event clusters that maximized the F₁ measure was adopted. Thus, to compare a set of automatically obtained clusters with a set of gold standard clusters (here the “reference events”), the cluster from the gold standard clusters which is to be used to evaluate a given automatically obtained cluster was first identified. This was achieved by adopting the mapping between the identified clusters and the gold standard clusters that maximized the F₁ measure. F₁ is a function of precision and recall, as defined below. Then, having mapped each automatically obtained cluster to a respective gold standard cluster, micro-averaged precision and recall were computed.

In this task Precision and Recall are defined as follows:

$$\begin{matrix}Precision ( c ) = \frac{{d ( c )}_{true}}{{d ( c )}_{true} + {d ( c )}_{false}} , ∀ c ∈ C & ( 1 ) \\ Recall ( c ) = \frac{{d ( c )}_{true}}{{d ( c )}_{true} + {d ( c )}_{missing}} , ∀ c ∈ C \\ and \\ {F}_{1} as \text{:} \\ {F}_{1} ( c ) = 2 \frac{Precision ( c ) \cdot Recall ( c )}{Precision ( c ) + Recall ( c )} & ( 2 )\end{matrix}$$

where C is the set of produced clusters, d(c)ₜᵣᵤₑ is the set of documents in cluster c, that also appear in the corresponding cluster in G, and d(c)_{false} are those that are not included there. Thus:

$$\begin{matrix}Micro \text{-} averaged - precision ( C ) = \frac{{\sum }_{c ∈ C}^{ } {d ( c )}_{true}}{{\sum }_{c ∈ C}^{ } {d ( c )}_{true} + {\sum }_{c ∈ C}^{ } {d ( c )}_{false}} & ( 3 ) \\ Micro \text{-} averaged - recall ( C ) = \frac{{\sum }_{c ∈ C}^{ } {d ( c )}_{true}}{{\sum }_{c ∈ C}^{ } {d ( c )}_{true} + {\sum }_{c ∈ C}^{ } {d ( c )}_{missing}} & ( 4 )\end{matrix}$$

An F₁(C) can then be computed using the micro-averaged precision and recall values.

Based on the TDT5 dataset, the test set, T corresponds to the 6364 annotated documents, the gold standard, G, is the correct clustering of T as defined by human annotators, and the development set, D, corresponds to the entire TDT5 data set except T.

The clustering algorithm used for clustering the documents in the test set is based on cosine similarity, where each document d is represented by its feature vector v_{d} and each cluster c is represented by its centroid feature vector v_{c}. A document d is attached to an existing cluster c if sim(v_{d},v_{c})>θ. Any cluster whose mean time (the average of the timestamps of the news articles composing it) exceeds 12 days from the timestamp of d cannot be updated and is fixed. For these experiments, θ=0.2 was used. The same clustering algorithm is used for the development set in the case of edi.

Clustering was assessed under the following configurations:

1. c₁: clustering T based on unigrams.

2. c₂: clustering T based on unigrams and on predicates but without any dirt or edi feature-merging.

3. c₃: clustering T based on unigrams and on predicates with merging of predicates based on dirt.

4. c₄: clustering T based on unigrams and on predicates with merging of predicates based on edi. In this configuration, the clusters used for computing the update function of edi are the output of the incremental clustering algorithm based on unigrams applied on the development set, D.

### Results

Table 1 shows results corresponding to clustering obtained with γ₁ and γ₂=0.7 for configurations c₃ and c₄. This is a rough estimation of the upper quartile of the dirt values.

TABLE 1
Clustering results

| | Micro- | Micro- | |
|---|---|---|---|
| | Averaged | Averaged | F1(C) |
| Configuration | Precision (%) | Recall (%) | (%) |
| c: unigrams | 46.2 | 60.5 | 52.4 |
| c₂: unigrams + predicates | 46.0 | 58.0 | 51.3 |
| c₃: unigrams + predicates with | 46.1 | 57.1 | 51.0 |
| dirt merging | | | |
| c₄: unigrams + predicates with | 53.2 | 58.3 | 55.6 |
| edi merging | | | |

Improving the results of clustering based on unigrams is not an easy task and indeed, adding the predicates as features harmed clustering performance, and this was also the case even when those predicates were filtered with a dirt merging (c₃ configuration). A slight improvement of the results had been expected with the c₃ configuration. One explanation for the result could be that the effect of the correct merging has been masked by the effect of erroneous merging. Finally, if the merging is restricted by the edi measure, c₄ configuration, the results are clearly better. Compared to c₁, the recall decreased (−2.2%) but the precision substantially increased (+7.0%), eventually leading to a 3.2% increase in F₁.

While in the example, the inference rules are treated symmetrically, i.e., as paraphrases, in another embodiment, rule directionality may be considered. Rule directionality could be learned from temporal clustering and such directional rules may improve the performance of event clustering.

A method to refine inference rules based on temporal event clustering has thus been described and its utility demonstrated using lexical-syntactic rules on a document clustering task. It is to be appreciated that the same approach can be applied to other types of rules and to other inference-based tasks.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for computing similarity comprising:
extracting corpus statistics for triples from a corpus of text documents, each triple comprising a predicate and first and second arguments of the predicate;
clustering documents in the corpus to form a set of clusters based on textual similarity and temporal similarity;
with a processor, computing an event-based path similarity between first and second paths, the first path comprising a first predicate and first and second argument slots, the second path comprising a second predicate and first and second argument slots, the event-based path similarity being computed as a function of:
a corpus statistics-based similarity score which is a function of the corpus statistics for the extracted triples which are instances of the first and second paths, and
a cluster-based similarity score which is a function of occurrences of the first and second predicates in the clusters.

2. The method of claim 1, wherein the method further comprises parsing text sequences of the documents in the corpus to generate parse trees and identifying the triples from the parse trees.

3. The method of claim 1, wherein the clustering of the documents comprises generating a feature based representation of each document based on words of the document.

4. The method of claim 1, wherein the clustering of the documents comprises, for each of a set of the documents, assigning the document to an existing cluster based on textual features of the document when a threshold textual similarity with the documents already assigned to the cluster is met and a temporal stamp for the document meets a predefined similarity with a temporal stamp at least one of the documents in the cluster, otherwise assigning the document to a new cluster.

5. The method of claim 1, wherein the computing of the corpus statistics-based similarity score comprises computing a first similarity measure between the first slot of each of the first and second paths, based on the corpus statistics, and computing a second similarity measure between the second slot of each of the first and second paths, based on the corpus statistics, and computing the corpus statistics-based similarity score as a function of the computed first similarity and second similarity.

6. The method of claim 5, wherein the computing of the first similarity measure comprises for a term in the corpus which appears in at least one of the triples as the first argument of the first predicate and in at least one of the triples as the first argument of the second predicate, computing pointwise mutual information between the term and its respective predicate.

7. The method of claim 1, wherein the occurrences of each of the first and second predicates in the clusters is represented as a respective vector and the cluster-based similarity score is computed as a function of a computed similarity between the two vectors.

8. The method of claim 7 wherein the similarity between the first and second vectors is computed as the cosine similarity between the two vectors.

9. The method of claim 7, wherein the occurrences of each of the first and second predicates in the clusters is expressed as a respective vector of binary values.

10. The method of claim 1 wherein the event-based path similarity being computed as a function of a product of the corpus statistics-based similarity score and the cluster-based similarity score.

11. The method of claim 1, further comprising storing a triple index in which each triple is associated with a respective value corresponding to a number of its occurrences in the corpus, and the extracting of the corpus statistics for the extracted triples which are instances of the first and second paths comprising extracting the corpus statistics from the triple index.

12. The method of claim 1, further comprising storing an index in which each of a set of predicates is associated with a respective value for each of the clusters corresponding to an occurrence of at least one instance of the predicate in the cluster, the occurrences of the first and second predicates in the clusters being extracted from the index.

13. The method of claim 1, further comprising outputting the event-based path similarity.

14. The method of claim 1, further comprising generating an inference rule based on the first and second predicates when the computed event-based path similarity meets a predefined threshold event-based path similarity.

15. The method of claim 14, further comprising applying the inference rule in an application selected from document clustering, information retrieval, document summarization, text categorization, machine translation, document authoring, and identification of textual entailment.

16. A computer program product comprising a non-transitory recording medium storing instructions, which when executed on a computer causes the computer to perform the method of claim 1.

17. A system comprising memory which stores instructions for performing the method of claim 1 and a processor in communication with the memory which implements the instructions.

18. A system comprising:
a triple extraction component which extracts corpus statistics for triples from a corpus of text documents, each triple comprising a predicate and first and second arguments of the predicate;
a clustering component for clustering documents in the corpus to form a set of clusters based on textual similarity and temporal similarity;
a path similarity component for computing an event-based path similarity between first and second paths, the first path comprising a first predicate and first and second argument slots, the second path comprising a second predicate and first and second argument slots, the event-based path similarity being computed as a function of:
a corpus statistics-based similarity score which is a function of the corpus statistics for the extracted triples which are instances of the first and second paths, and
a cluster-based similarity score which is a function of occurrences of the first and second predicates in the clusters; and
a processor which implements the triple extraction component, clustering component, and path similarity component.

19. The system of claim 18, further comprising a parser which parses text sequences of the documents in the corpus to generate parse trees, the triple extraction component using the parse trees for identifying the triples.

20. The system of claim 18, further comprising an inference rule generator which generates an inference rule based on the first and second predicates when the computed event-based path similarity meets a predetermined threshold.

21. A method for refining inference rules comprising:
computing a first similarity score for first and second paths based on corpus statistics extracted for triples from a corpus of text documents, the first path comprising a first predicate and first and respective second argument slots, the second path comprising a second predicate and respective first and second argument slots, each triple comprising one of the first and second predicates and first and second arguments of the predicate that are instances of the respective first and second argument slots;
computing a second similarity score for the first and second paths based on a similarity between occurrences of the paths in a set of document clusters formed by clustering documents in the corpus based in part on temporal stamps of the documents;
computing an event-based path similarity between first and second paths as a function of the first and second similarity scores; and
generating an inference rule for the first and second paths based on whether the event-based path similarity meets a predetermined threshold.
